(19) United States
(12) Patent Application Publication
(10) Pub. No.: US 2025/0292167 A1
(43) Pub. Date: Sep. 18, 2025

(54) Production Management Analysis Method and Production Management System

(71) Applicants: Inventec (Pudong) Technology Corp., Shanghai (CN); Inventec Corporation, Taipei (TW)

(72) Inventors: Wei-Chao Chen, Taipei (TW); Ming-Chi Chang, Taipei (TW); Ghih-Pin Wei, Taipei (TW)

(73) Assignees: Inventec (Pudong) Technology Corp., Shanghai (CN); Inventec Corporation, Taipei (TW)

(21) Appl. No.: 18/661,751

(22) Filed: May 13, 2024

(30) Foreign Application Priority Data
Mar. 15, 2024 (CN) 202410302761.6

(51) Int. Cl. G06Q 10/0631

(52) U.S. Cl. CPC G06Q 10/063114

(57) ABSTRACT

A production management analysis method is provided. The production management analysis method includes obtaining a plurality of work orders every a predetermined time interval, each work order corresponding to a process, and each work order including information of an order status of the work order, wherein the plurality of work orders are generated by a work order processing device; determining order statuses and corresponding candidate status time of the plurality of work orders when obtaining the plurality of work orders each time, so as to generate a work order change table; determining processing time of the process corresponding to the plurality of work orders according to the work order change table to generate a process duration table; and creating a production management visual chart according to the work order change table, the process duration table and a process reference table.

### BACKGROUND OF THE INVENTION

### 1. Field of the Invention

The present invention relates to a production management analysis method and a production management system, and more particularly, to a production management analysis method and a production management system based on work order system.

### 2. Description of the Prior Art

When companies or organizations undergo digital transformation, they must perform the data governance process on important data, such as financial statements, inventory aging and manufacturing expenses, to standardize data formats, validate the accuracy of data and verify data accuracy, in order to establish a complete data governance system. For example, related data governance processes or sub-processes of the company data governance process may be developed or defined according to IBM data governance program principles. The work order management system may create work orders based on project items and execute the work orders, to ensure that all necessary tasks have actually been completed. However, work order information can only be used to confirm and trace whether the data governance process has been completed, and cannot reflect the processing procedure of the data governance process. For example, enterprise managers or data management end users cannot understand the overall time cost of the project topic. In the absence of time and cost analysis information for data governance, the progress of data governance would not be effectively managed, thus resulting in additional cost due to improper allocation of manpower and data governance delay. As such, it is impossible to evaluate the completion time of data governance for new topic, and also impossible to evaluate the actual data governance cost of project topics to determine whether the data governance process of new topic is worthy of being performed, thereby affecting the speed of digital transformation for the company. Thus, there is a need for improvement.

### SUMMARY OF THE INVENTION

It is therefore a primary objective of the present invention to provide a production management analysis method and a production management system based on work order system, in order to resolve the aforementioned problems.

The present invention discloses a production management analysis method, comprising: obtaining a plurality of work orders every a predetermined time interval, each work order corresponding to a process, and each work order comprising information of an order status of the work order, wherein the plurality of work orders is generated by a work order processing device, and the work order processing device modifies order statuses of the plurality of work orders according to execution statuses of the processes of the plurality of work orders; determining order statuses and corresponding candidate status time of the plurality of work orders when obtaining the plurality of work orders each time, so as to generate a work order change table, wherein the step comprises, for each work order, verifying the order status of the work order, determining current time as candidate status time corresponding to the order status of the work order and recording the candidate status time corresponding to the order status of the work order into the work order change table when obtaining the work order each time; determining processing time of the processes corresponding to the plurality of work orders according to the work order change table to generate a process duration table; and creating a production management visual chart according to the work order change table, the process duration table and a process reference table.

The present invention further discloses a production management system, comprising: a work order processing device, configured to generate a plurality of work orders and modify order statuses of the plurality of work orders according to execution statuses of the processes of the plurality of work orders, wherein each work order corresponds to a process, and each work order comprises information of an order status of the work order; a storage device, for storing the plurality of work orders; a processing circuit, coupled to the storage device, and configured to obtain the plurality of work orders every a predetermined time interval, determine order statuses and corresponding candidate status time of the plurality of work orders when obtaining the plurality of work orders each time, so as to generate a work order change table; wherein for each work order, the processing circuit is configured to verify the order status of the work order, determine current time as candidate status time corresponding to the order status of the work order and record the candidate status time corresponding to the order status of the work order into the work order change table when obtaining the work order each time, the processing circuit is configured to determine processing time of the processes corresponding to the plurality of work orders according to the work order change table to generate a process duration table and create a production management visual chart according to the work order change table, the process duration table and a process reference table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a production management system according to an embodiment of the present invention.

FIG. 2 is a schematic diagram illustrating the work order and the work order change table according to an embodiment of the present invention.

FIG. 3 is a flow diagram of a procedure according to an embodiment of the present invention.

FIG. 4 is a schematic diagram illustrating the data cleaning procedure of the work order change table according to an embodiment of the present invention.

FIG. 5 is a schematic diagram of a topic production management diagram based on the topic idle percentage index according to an embodiment of the present invention.

FIG. 6 is a schematic diagram of a process time cost analysis diagram according to an embodiment of the present invention.

### DETAILED DESCRIPTION

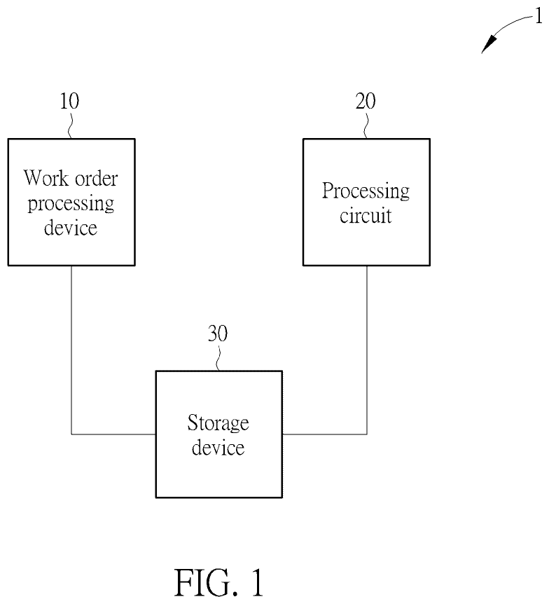

Please refer to FIG. 1, which is a schematic diagram of a production management system 1 according to an embodiment of the present invention. The production management system 1 includes a work order processing device 10, a processing circuit 20 and a storage device 30. The work order processing device 10 is configured to generate work orders and store the work orders into the storage device 30. Each work order includes a work order identifier (ID) and information associated with a process. Each work order uniquely corresponds to a process. The process specified in the work order may correspond to a topic, and the process is utilized for completing tasks of the corresponding topic. Each topic may include at least one process. For example, the topic may be a project topic of data governance, and the process corresponding to the topic may be utilized for completing tasks of the project topic of data governance. Each work order may include a work order identifier, information of order status of the work order, process information and topic information. The work order identifier is utilized to identify the work order and the work order identifier is unique. The information of the order status of the work order indicates the order status of the work order. The order statuses of the work order may include newly added (work order is created or scheduled), in progress and completed (work order is finished). The order status of the work order may change as follows, in order: newly added→in progress→completed. In addition, other work order statuses between the newly added status and the completed status, such as, but not limited to, development, verification, review, may also be included in the in progress status. The process information may include a process identifier of a process recorded in the work order and work schedules for the process. The process identifier is utilized to identify the process recorded in the work order. The topic information may include a topic identifier. The topic identifier is utilized to identify the topic corresponding to the process of the work order.

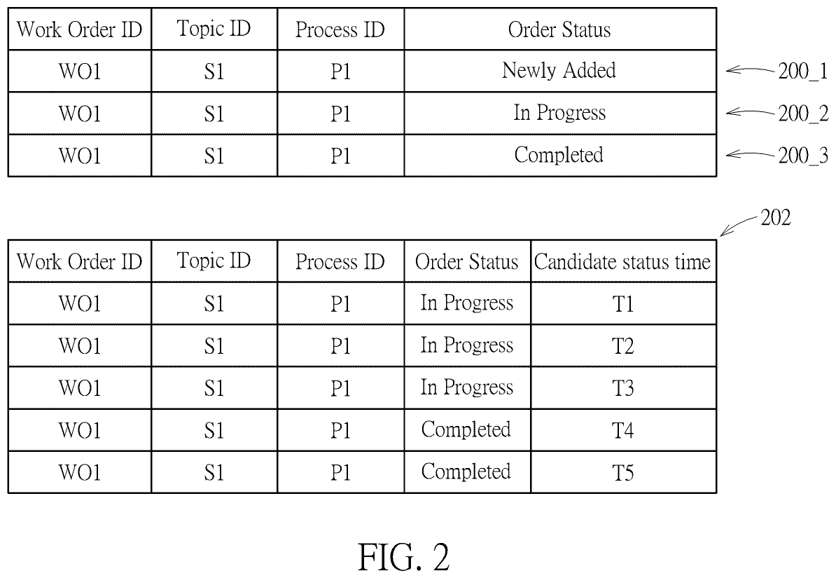

The work order processing device 10 may modify the order status recoded in the work order according to the execution situation of the process, and store the modified work order into the storage device 30 to replace the previously stored work order. As shown in FIG. 2, a work order with work order identifier WO1 corresponds to a process P1, and the process P1 corresponds to a topic S1. The work order processing device 10 creates a work order 200_1 with a work order identifier WO1. As shown in FIG. 2, the order status recorded in the work order 200_1 is “newly added”. After creating the work order 200_1 (the work order identifier ID is WO1), the work order processing device 10 stores the work order 200_1 into the storage device 30. As the process P1 has started executing, the work order processing device 10 modifies the order status from “newly added” to “in progress” to generate a modified work order 200_2, and stores the modified work order 200_2 into the storage device 30. When the process P1 has been completed, the work order processing device 10 modifies the order status from “in progress” to “completed” to generate a modified work order 200_3, and stores the modified work order 200_3 into the storage device 30. As shown in FIG. 2, the work orders 200_1, 200_2 and 200_3 are the same work order with the work order identifier WO1, and the order statuses recorded in work orders 200_1, 200_2 and 200_3 are different. In an embodiment, the work order processing device 10 may generate work orders and modify the order status specified in the work order according to execution situations of the process through executing software application, such as Microsoft List software, Microsoft Excel software, DevOps software or Mantis software, but not limited thereto.

In addition, the process specified in the work order may correspond to a topic, and each topic may include multiple processes. In the production management system 1, all processes of each topic may be recorded, and the execution order of all processes for each topic may also be recorded, so as to generate a process reference table. The process reference table may be stored into the storage device 30 for subsequent retrieval. For example, the process reference table may be generated according to IBM data governance process principles, and the process reference table may be stored in the storage device 30.

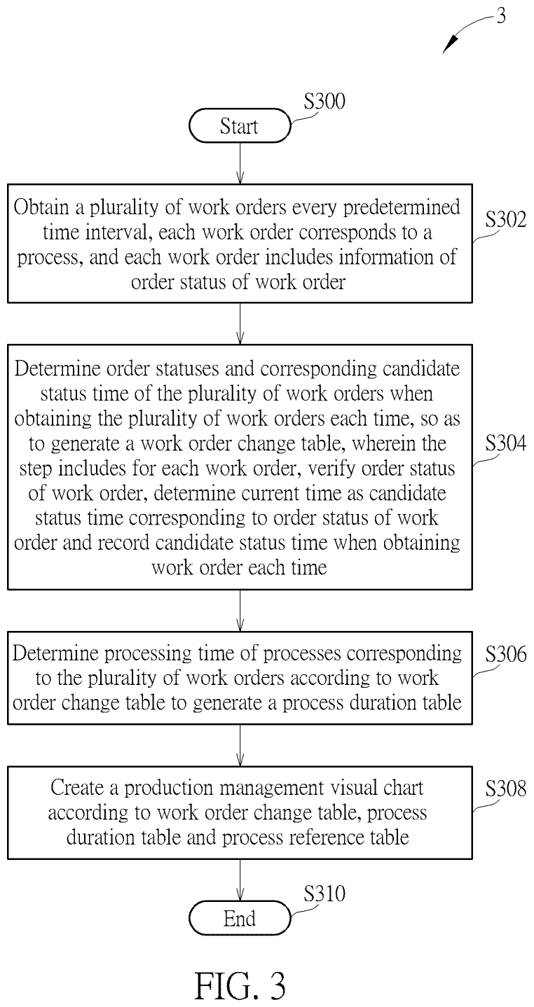

Please refer to FIG. 3. FIG. 3 is a flow diagram of a procedure 3 according to an embodiment of the present invention. The procedure 3 includes the following steps:
Step S300: Start.
Step S302: Obtain a plurality of work orders every predetermined time interval, each work order corresponds to a process, and each work order includes information of order status of work order.
Step S304: Determine order statuses and corresponding candidate status time of the plurality of work orders when obtaining the plurality of work orders each time, so as to generate a work order change table, wherein the step includes for each work order, verify order status f work order, determine current time as candidate status time corresponding to order status of work order and record candidate status time corresponding to order status of work order into work order change table when obtaining work order each time.
Step S306: Determine processing time of processes corresponding to the plurality of work orders according to work order change table to generate a process duration table.
Step S308: Create a production management visual chart according to work order change table, process duration table and process reference table.
Step S310: End.

According to the procedure 3, in Step S302, the work order processing device 10 may generate a plurality of work orders and store the plurality of work orders into the storage device 30 during operation of the production management system 1. Furthermore, for each work order, the work order processing device 10 may modify the order status recorded in the work order according to the execution status of the process and store the modified work order into the storage device 30. Each work order corresponds to a process, and each work order includes information of the order status of the work order. The processing circuit 20 may access the plurality of work orders stored in the storage device 30 at different times. For example, the processing circuit 20 accesses the plurality of work orders stored in the storage device 30 every a predetermined time interval to obtain and analyze the accessed work orders.

In Step S304, the work order processing device 10 may determine order statuses and corresponding candidate status time of the plurality of work orders when obtaining the plurality of work orders each time, so as to generate a work order change table. The work order change table may be stored into the storage device 30 by the work order processing device 10. For example, for each work order, the work order processing device 10 may check and verify the order status of the work order and determine current time as candidate status time corresponding to the order status of the work order when obtaining the work order each time. Furthermore, the work order processing device 10 may record the candidate status time corresponding to the order status of the work order into the work order change table when obtaining the work order each time. For example, as shown in FIG. 2, time points T1 to T5 arranged in chronological order are: T1-T2-T3-T4-T5. At time T1, the work order 200_2 with a work order identifier WO1 is stored in the storage device 30. At time T1, the processing circuit 20 reads the work order with the work order identifier WO1 (i.e., work order 200_2) from the storage device 30 and determines that the order status specified in the work order 200_2 is in progress. The processing circuit 20 determines the current time (i.e., T1) as candidate status time corresponding to the order status (i.e., in progress) of the work order 200_2. As such, the order status (i.e., in progress) of the work order 200_2, the corresponding candidate status time (i.e., T1), topic (i.e., topic ID S1) and process (process ID P1) may be recorded in the work order change table by the processing circuit 20.

At time T2 and T3, since the process P1 is still in progress, the work order with the work order identifier WO1 stored in the storage device 30 is still the work order 200_2. Therefore, at time T2, the processing circuit 20 accesses the work order 200_2 with the work order identifier WO1 from the storage device 30 and determines the current time (i.e., T2) as candidate status time corresponding to the order status (i.e., in progress) of the work order with the work order identifier WO1. At time T3, the processing circuit 20 accesses the work order 200_2 with the work order identifier WO1 from the storage device 30 and determines the current time (i.e., T3) as candidate status time corresponding to the order status (i.e., in progress) of the work order with the work order identifier WO1. At time T4, since the process P1 has been completed, the work order processing device 10 has modified the order status of the work order from “in progress” to “completed”. At time T4, the work order with the work order identifier WO1 stored in the storage device 30 is the work order 200_3. At time T4, the processing circuit 20 reads the work order with the work order identifier WO1 (i.e., work order 200_3) from the storage device 30 and determines that the order status recorded in the work order 200_3 is completed. The processing circuit 20 determines the current time (i.e., T4) as candidate status time corresponding to the order status (i.e., completed) of the work order with the work order identifier WO1, and records related information into the work order change table. In other words, the processing circuit 20 continues to access the information of work orders in the storage device 30 at different times, and each order status in the same work order may have multiple corresponding candidate status time. The work order change table may record time information of order status change for each work order. In addition, when the work order includes timestamp information of the order status, the processing circuit 20 may also retrieve the timestamp information recorded in the work order to generate the work order change table.

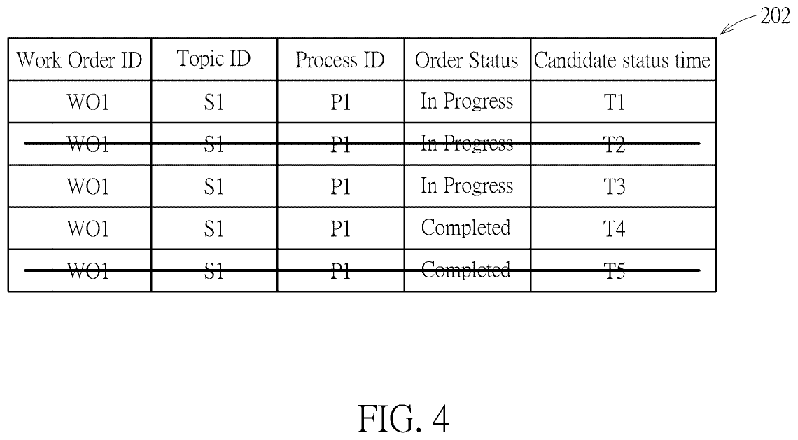

On the other hand, since the processing circuit 20 continues to access the information of work orders in the storage device 30 at different times, and each order status in the same work order may have multiple corresponding candidate status time. The processing circuit 20 may perform a data cleaning process on the work order change table based on the order statuses of the plurality of work orders. For each work order, the processing circuit 20 determines all candidate status time corresponding to the “in progress” order status of the work order (i.e., order status of the work order is in progress) from the work order change table, and retains the earliest candidate status time and the latest candidate status time corresponding to the “in progress” order status of the work order in the work order change table. For example, as shown in FIG. 4, for the work order with the work order identifier WO1, all candidate status time corresponding to the “in progress” order status are T1, T2 and T3 respectively. The processing circuit 20 may retain the earliest candidate status time T1 and the latest candidate status time T3 corresponding to the work order with the work order identifier WO1, and remove the candidate status time T2. For each work order, the processing circuit 20 determines all candidate status time corresponding to the “completed” order status of the work order (i.e., order status of the work order is completed) from the work order change table, and retains the earliest candidate status time corresponding to the “completed” order status of the work order in the work order change table. For example, as shown in FIG. 4, for the work order with the work order identifier WO1, all candidate status time corresponding to the “completed” order status are T4 and T5 respectively. The processing circuit 20 may retain the earliest candidate status time T4 and remove the candidate status time T5 for performing the data cleaning process, thereby facilitating to quickly and correctly generate the process duration table.

In Step S306, the processing circuit 20 may access the work order change table stored in the storage device 30 and determine the process time of the processes corresponding to the plurality of work orders according to the work order change table to generate a process duration table. Since each work order uniquely corresponds to a process, the order status of the work order may be utilized as the process status of the process recorded in the work order, and the candidate status time of the order status may be utilized as the candidate status time of the process. For the process recorded in each work order, the processing circuit 20 determines starting time, finishing time, processing time of the process of each work order and information on whether the process is completed according to the information of the work order change table. The processing circuit 20 determines the earliest candidate status time corresponding to the “in progress” order status (i.e., order status is in progress) of each work order from the work order change table. The processing circuit 20 determines the earliest candidate status time as starting time of the process corresponding to the work order. Further, the processing circuit 20 determines whether there is information corresponding to the “completed” order status (i.e., order status is completed) of the work order in the work order change table. When determining that there is information corresponding to the “completed” order status of the work order in the work order change table, the processing circuit 20 determines the candidate status time corresponding to the “completed” order status of the work order as finishing time of the process corresponding to the work order. When determining that there is no information corresponding to the “completed” order status of the work order in the work order change table, the processing circuit 20 determines the latest candidate status time corresponding to the “in progress” order status of the work order from the work order change table and determines the latest candidate status time corresponding to the “in progress” order status as finishing time of the process corresponding to the work order.

Moreover, the processing circuit 20 may calculate the time length from the starting time of the process corresponding to the work order to the finishing time of the process corresponding to the work order, so as to obtain the processing time of the process. For example, the processing circuit 20 may calculate the number of calendar days from the starting time of the process to the finishing time of the process to obtain the processing time of the process. In an alternative embodiment, the processing circuit 20 may calculate the number of working days between the starting time and the finishing time of the process to obtain the processing time of the process. The processing circuit 20 may record the information of the topic identifier of the topic corresponding to the process of each work order, the information of the process identifier, the starting time, the finishing time and the processing time of the processes and the information indicating whether the process is completed into the process duration table.

The processing circuit 20 may store the process duration table into the storage device 30. The process duration table may be stored into the storage device 30 for subsequent retrieval. The process duration table may record time information of processing procedure of each process. Since each topic may include at least one process. All the processes corresponding to the topic identifier of a topic may be identified and determined from the process duration table and the information associated with all processes corresponding to the topic identifier of the topic may be retrieved for subsequent analysis.

In Step S308, the processing circuit 20 may create a production management visual chart according to the work order change table, the process duration table and the process reference table. Each topic may include a plurality of processes. For each topic, the processing circuit 20 may access the process reference table in the storage device 30 and determine all processes of the topic according to the process reference table. The processing circuit 20 may access time information of all processes of the topic in the process duration table. The processing circuit 20 may calculate a topic idle percentage index of the topic according to the time information of all processes of the topic. For example, for each topic, the processing circuit 20 may access the process duration table stored in the storage device 30 and retrieve the processing time of each process corresponding to the topic from the process duration table. The processing circuit 20 may calculate a summation of the processing time of all processes corresponding to the topic. The processing circuit 20 may retrieve the starting time of all process corresponding to the topic from the process duration table. The processing circuit 20 may determine an earliest starting time among the start time of all processes corresponding to the topic for acting as starting time of the topic. The processing circuit 20 may retrieve the finishing time of all process corresponding to the topic from the process duration table. The processing circuit 20 may determine a latest finishing time among the finishing time of all processes corresponding to the topic for acting as finishing time of the topic. The processing circuit 20 may calculate the number of calendar days from the starting time of the topic to the finishing time of the topic to obtain the number of elapsed days (processing days) of the topic. In an alternative embodiment, the processing circuit 20 may calculate the number of working days between the starting time and the finishing time of the topic to obtain the number of elapsed days of the topic. The processing circuit 20 may calculate a topic idle percentage index of the topic according to the summation of the processing time of all processes corresponding to the topic and the number of elapsed days of the topic. For example, the topic idle percentage index may be calculated by the processing circuit 20 according to the following equation:

$$S I {R}_{n} = ( 1 - Xn / Yn ) \times 100 \% \qquad ( 1 )$$

where SIRₙ represents the topic idle percentage index of the n-th topic, Xn represents the summation of the processing time of all processes of the i-th topic, and Yn represents the number of elapsed days of the i-th topic.

For each topic, the topic idle percentage index may reflect the proportion of time (days) spent on the in progress or completed order status for the topic. The topic idle percentage index may reflect the percentage of time spent without working for the work order or process. The lower the topic idle percentage index is, the higher the labor cost is in the time cost. The higher the topic idle percentage index is, the higher the time cost that the topic would consume.

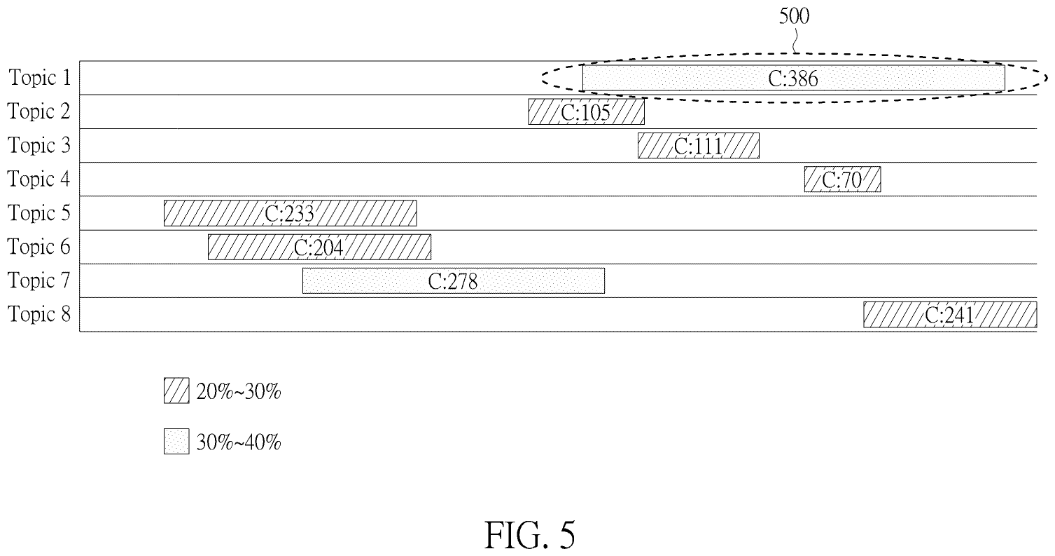

Further, the processing circuit 20 may access the work order change table stored in the storage device 30 to determine status information of the last process of each topic, so as to determine whether the last process of the topic has been completed. In an embodiment, the production management visual chart includes a topic production management diagram. The processing circuit 20 may create a topic production management diagram according to the topic idle rate index, the number of elapsed days, starting time, finishing time and status information of the last process of all topics, and visualize (visually display) the topic production management diagram. Therefore, the idle situation during the execution of the topic processes may be presented, such that the manager is able to quickly and clearly understand and handle the overall execution situation. For example, please refer to FIG. 5. FIG. 5 is a schematic diagram of a topic production management diagram based on the topic idle percentage index according to an embodiment of the present invention. As shown in FIG. 5, each horizontal bar represents the execution situation of a data governance process of a topic. The starting point of the horizontal bar represents the starting time of the topic, and the ending point of the horizontal bar represents the finishing time of the topic. The text C in the horizontal bar indicates that the data governance process of the topic is completed (i.e. process status is at completed status), and the text P in the horizontal bar indicates that the data governance process of the topic is in progress ((i.e. process status is at in progress status). The number shown in the horizontal bar represents the number of elapsed days (calendar days) of the topic. The background stripe and pattern of the horizontal bar represents the topic idle percentage index value. For example, take topic 1 (identified by the circle labeled 500 shown in FIG. 5) as an example. The topic 1 is a topic that has completed the data governance process. The number of elapsed days (calendar days) of the topic 1 is 386 days. This means, the number of elapsed days of the topic 1 is longer than the number of elapsed days of other topics. Moreover, the topic 1 spends less time idle during the data governance process. Therefore, the total labor cost of the topic 1 may be higher than other topics.

In an alternative embodiment, the production management visual chart includes a topic relative production management diagram. For each topic, the processing circuit 20 may calculate the percentile of the topic idle percentage index of the topic among the topic idle percentage indexes of all topics, so as to obtain a topic idle relative index of the topic. The processing circuit 20 may create the topic relative production management diagram according to the topic idle relative index, the number of elapsed days, starting time, finishing time and status information of the last process of all topics, and visualize the topic relative production management diagram based on the topic idle relative index. For example, please further refer to FIG. 5. The background stripe and pattern of the horizontal bar may be changed to represent the topic idle relative index to indicate the relative idle status of different topics. The topic idle relative index generated based on the topic idle percentage index reflects a cost comparison between different topics. After converting the topic idle indexes of all topics into percentiles, topics with more abnormal idle status may be filtered out. In a mature process, the time and labor costs of each topic may be similar. When the idle status of the most abnormal topic is within an acceptable range, this means that the overall data governance process is in a healthy state. Therefore, the topic idle relative index of the embodiments of present invention may be utilized to find out the topic with the lowest index and the topic the highest index and performing a difference comparison on the topic with the lowest index and the topic the highest index in order to understand whether the current process has become a mature process.

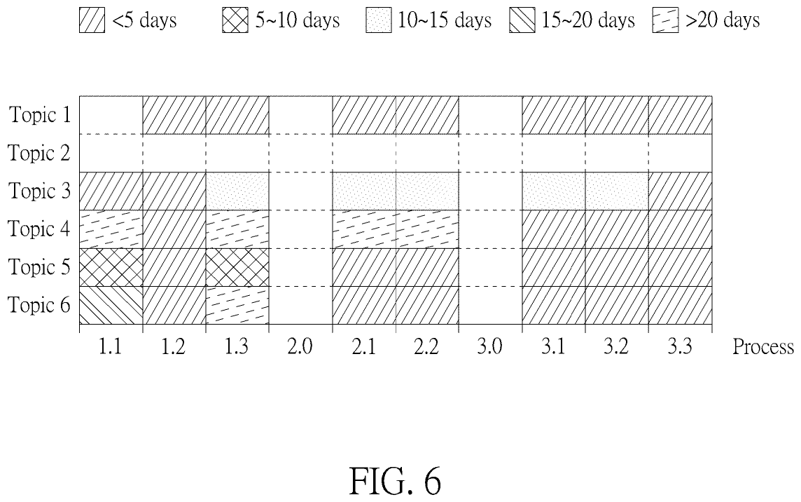

In an embodiment, the production management visual chart includes a process time cost analysis diagram. The processing circuit 20 may access the process reference table stored in the storage device 30 and determine all processes of the topic according to the process reference table. For each topic, the processing circuit 20 may access the process reference table stored in the storage device 30 and retrieve the processing time of each process of the topic in the process reference table. The processing circuit 20 may create a process time cost analysis diagram of the production management visual chart according to the processes and processing time of the processes of all topics, and visualize the processing time cost analysis diagram. FIG. 6 is a schematic diagram of a process time cost analysis diagram according to an embodiment of the present invention. As shown in FIG. 6, each horizontal bar represents processes of a topic. The background stripe and pattern of the horizontal bar represents the processing time of the process. Through the process time cost analysis diagram in FIG. 6, managers may evaluate the time cost distribution for each process. For example, the topics corresponding to the process 1.3 takes more time, and the topics corresponding to process 3.3 takes less time. In comparison, the process 1.3 is a process that consumes more time. Therefore, when a new topic needs to be prepared for data governance, managers may understand that the process 1.3 will require more time than the process 3.3 according to the process time cost analysis diagram. As the number of topics of data governance increases, more and more data (e.g., data shown in FIG. 6) may be used. Therefore, through the process time cost analysis diagram of the production management visual chart, the embodiments of present invention may improve the accuracy of evaluating the estimated processing time of processes for a new topic estimating and make the production management of the data governance process more mature.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system, the production management system 1 or combination thereof. Examples of hardware can include analog, digital and/or mixed circuits known as microcircuit, microchip, or silicon chip. For example, the hardware may include application-specific integrated circuit (ASIC), field programmable gate array (FPGA), programmable logic device, coupled hardware components or combination thereof. In another example, the hardware may include general-purpose processor, microprocessor, controller, digital signal processor (DSP) or combination thereof. Examples of the software may include set(s) of codes, set(s) of instructions and/or set(s) of functions retained (e.g., stored) in a storage device, e.g., a non-transitory computer-readable medium. The non-transitory computer-readable storage medium may include read-only memory (ROM), flash memory, random access memory (RAM), subscriber identity module (SIM), hard disk, floppy diskette, or CD-ROM/DVD-ROM/BD-ROM, but not limited thereto. The production management system 1 of the embodiments of the invention may include the processing circuit 20 and the storage device 30. Any of the abovementioned procedures and examples above may be compiled into program codes or instructions that are stored in the storage device 30 or a computer-readable medium. The processing circuit 20 may read and execute the program codes or the instructions stored in the storage device 30 or computer-readable medium for realizing the abovementioned functions.

To sum up, the embodiments of the present invention may determine the candidate status time of the corresponding work order status by continuing to access the work order information at different times so as to generate and visually display the corresponding work order change table and the process duration table. Therefore, the embodiments of the present invention may allow managers to quickly and clearly get the corresponding execution situation of the overall process, understand the difficulty of different processes and effectively allocate manpower, and thus ensuring the successful completion of the topic governance process.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A production management analysis method, comprising:
obtaining a plurality of work orders every a predetermined time interval, each work order corresponding to a process, and each work order comprising information of an order status of the work order, wherein the plurality of work orders is generated by a work order processing device, and the work order processing device modifies order statuses of the plurality of work orders according to execution statuses of the processes of the plurality of work orders;
determining order statuses and corresponding candidate status time of the plurality of work orders when obtaining the plurality of work orders each time, so as to generate a work order change table, wherein the step comprises, for each work order, verifying the order status of the work order, determining current time as candidate status time corresponding to the order status of the work order and recording the candidate status time corresponding to the order status of the work order into the work order change table when obtaining the work order each time;
determining processing time of the processes corresponding to the plurality of work orders according to the work order change table to generate a process duration table; and
creating a production management visual chart according to the work order change table, the process duration table and a process reference table.

2. The production management analysis method of claim 1, further comprising:
performing a data cleaning process on the work order change table based on the order statuses of the plurality of work orders, wherein the step comprises for each work order, determining all candidate status time corresponding to the order status being in progress of the work order from the work order change table and retaining the earliest candidate status time and the latest candidate status time corresponding to the order status being in progress of the work order in the work order change table, and for each work order, determining all candidate status time corresponding to the order status being completed of the work order from the work order change table and retaining the earliest candidate status time corresponding to the order status being completed of the work order in the work order change table.

3. The production management analysis method of claim 1, wherein the step of determining the processing time of the processes corresponding to the plurality of work orders according to the work order change table to generate the process duration table comprises:
for each work order, determining the earliest candidate status time corresponding to the order status being in progress of the work order from the work order change table and determining the earliest candidate status time as starting time of the process corresponding to the work order;
for each work order, determining whether there is information corresponding to the order status being completed of the work order in the work order change table, and when determining that there is no information corresponding to the order status being completed in the work order change table, determining the latest candidate status time corresponding to the order status being in progress of the work order from the work order change table and determining the latest candidate status time as finishing time of the process corresponding to the work order;
when determining that there is information corresponding to the order status being completed in the work order change table, determining the candidate status time corresponding to the order status being completed of the work order from the work order change table and determining the candidate status time as finishing time of the process corresponding to the work order; and
calculating a time length from the starting time of the process to the finishing time of the process corresponding to the work order to obtain the processing time of the process, and recording the starting time, the finishing time and the processing time of the process into the process duration table.

4. The production management analysis method of claim 1, wherein the step of creating the production management visual chart according to the work order change table, the process duration table and the process reference table comprises:
obtaining the process reference table, determining all processes of each topic according to the process reference table, accessing time information of all processes of the topic in the process duration table, and calculating a topic idle percentage index of the topic according to the time information of all processes of the topic; and
creating a topic production management diagram of the production management visual chart according to the idle percentage index, the number of elapsed days, the starting time, the finishing time and the status information of the last process of each topic, and visualizing the topic production management diagram.

5. The production management analysis method of claim 4, further comprising:
For each topic, calculating the percentile of the topic idle percentage index of the topic among the topic idle percentage indexes of all topics to obtain a topic idle relative index of the topic; and
creating the topic production management diagram of the topic production management chart according to the topic idle relative index, the number of elapsed days, the starting time, the finishing time and status information of the last process of each topic, and visualizing the topic production management diagram.

6. The production management analysis method of claim 1, wherein the step of creating the production management visual chart according to the work order change table, the process duration table and a process reference table comprises:
obtaining the process reference table, determining all processes of each topic according to the process reference table, and accessing processing time of all processes of the topic from the process duration table to create a process time cost analysis diagram of the production management visual chart, and visualizing the processing time cost analysis diagram.

7. A production management system, comprising:
a work order processing device, configured to generate a plurality of work orders and modify order statuses of the plurality of work orders according to execution statuses of the processes of the plurality of work orders, wherein each work order corresponds to a process, and each work order comprises information of an order status of the work order;
a storage device, for storing the plurality of work orders;
a processing circuit, coupled to the storage device, and configured to obtain the plurality of work orders every a predetermined time interval, determine order statuses and corresponding candidate status time of the plurality of work orders when obtaining the plurality of work orders each time, so as to generate a work order change table;
wherein for each work order, the processing circuit is configured to verify the order status of the work order, determine current time as candidate status time corresponding to the order status of the work order and record the candidate status time corresponding to the order status of the work order into the work order change table when obtaining the work order each time, the processing circuit is configured to determine processing time of the processes corresponding to the plurality of work orders according to the work order change table to generate a process duration table and create a production management visual chart according to the work order change table, the process duration table and a process reference table.

8. The production management system of claim 7, wherein the processing circuit is configured to perform a data cleaning process on the work order change table based on the order statuses of the plurality of work orders, for each work order, the processing circuit is configured to determine all candidate status time corresponding to the order status being in progress of the work order from the work order change table and retain the earliest candidate status time and the latest candidate status time corresponding to the order status being in progress of the work order in the work order change table, and for each work order, and the processing circuit is configured to determine all candidate status time corresponding to the order status being completed of the work order from the work order change table and retain the earliest candidate status time corresponding to the order status being completed of the work order in the work order change table.

9. The production management system of claim 7, wherein for each work order, the processing circuit is configured to determine the earliest candidate status time corresponding to the order status being in progress of the work order from the work order change table and determine the earliest candidate status time as starting time of the process corresponding to the work order, the processing circuit is configured to determine whether there is information corresponding to the order status being completed of the work order in the work order change table, when determining that there is no information corresponding to the order status being completed in the work order change table, the processing circuit is configured to determine the latest candidate status time corresponding to the order status being in progress of the work order from the work order change table and determine the latest candidate status time as finishing time of the process corresponding to the work order, and when determining that there is information corresponding to the order status being completed in the work order change table, the processing circuit is configured to determine the candidate status time corresponding to the order status being completed of the work order from the work order change table and determine the candidate status time as finishing time of the process corresponding to the work order, and the processing circuit is configured to calculate a time length from the starting time of the process to the finishing time of the process corresponding to the work order to obtain the processing time of the process, and record the starting time, the finishing time and the processing time of the process into the process duration table.

10. The production management system of claim 7, wherein the processing circuit is configured to obtain the process reference table, determine all processes of each topic according to the process reference table, access time information of all processes of the topic in the process duration table and calculate a topic idle percentage index of the topic according to the time information of all processes of the topic, and the processing circuit is configured to create a topic production management diagram of the production management visual chart according to the idle percentage index, the number of elapsed days, the starting time, the finishing time and the status information of the last process of each topic, and visualize the topic production management diagram.

11. The production management system of claim 10, wherein for each topic, the processing circuit is configured to calculate the percentile of the topic idle percentage index of the topic among the topic idle percentage indexes of all topics to obtain a topic idle relative index of the topic, the processing circuit is configured to create the topic production management diagram of the topic production management chart according to the topic idle relative index, the number of elapsed days, the starting time, the finishing time and status information of the last process of each topic, and visualize the topic production management diagram.

12. The production management system of claim 7, wherein the processing circuit is configured to obtain the process reference table, determine all processes of each topic according to the process reference table, access processing time of all processes of the topic from the process duration table to create a process time cost analysis diagram of the production management visual chart, and visualize the processing time cost analysis diagram.
